(19) United States
(12) Patent Application Publication
(10) Pub. No.: US 2008/0249275 A1
(43) Pub. Date: Oct. 9, 2008

(54) RADIATION SHIELDING WITH POLYHEDRAL OLIGOMERIC SILSESQUIOXANES AND METALLIZED ADDITIVES

(76) Inventors: Joseph D. Lichtenhan, Petal, MS (US); Xuan Fu, Purvis, MS (US); Paul Wheeler, Hattiesburg, MS (US)

Correspondence Address: PILLSBURY WINTHROP SHAW PITTMAN LLP, P.O. BOX 10500, MCLEAN, VA, 22102, US

(21) Appl. No.: 11/847,847

(22) Filed: Aug. 30, 2007

Related U.S. Application Data
(63) Continuation-in-part of application No. 11/015,185, filed on Dec. 17, 2004.
(60) Provisional application No. 60/824,040, filed on Aug. 30, 2006.
(60) Provisional application No. 60/531,458, filed on Dec. 18, 2003.

(51) Int. Cl. C08G 79/00; C08G 77/00

(52) U.S. Cl. 528/9; 528/10

(57) ABSTRACT

Nanoscopic metallized and nonmetallized nanoscopic silicon containing agents including polyhedral oligomeric silsesquioxane and polyhedral oligomeric silicate provide radiation absorption and in situ formation of nanoscopic glass layers on material surfaces. These property improvements are useful in space-survivable materials, microelectronic packaging, and radiation absorptive paints, coatings and molded articles.

### CROSS-REFERENCE TO RELATED APPLICATIONS

This application claims the benefit of U.S. Provisional Patent Application Ser. No. 60/824,040 filed Aug. 30, 2006, and is a continuation-in-part of U.S. patent application Ser. No 11/015,185 filed Dec. 17, 2004, which claims the benefit of U.S. Provisional Patent Application Ser. No. 60/531,458 filed Dec. 18, 2003.

### FIELD OF THE INVENTION

The present invention relates generally to methods for shielding electronics from damage by neutron, x-ray, proton, electron, vacuum ultraviolet and ultraviolet radiation. The invention uses nanoscopic silicon containing agents with metals for radiation absorption.

### DESCRIPTION OF THE PRIOR ART

This invention relates to use of polyhedral oligomeric silsesquioxane, silsesquioxane, polyhedral oligomeric silicate, silicates, and silicones or metallized-polyhedral oligomeric silsesquioxane, silsesquioxane, polyhedral oligomeric silicate, silicates, and silicones as alloyable agents in combination with metallic powders and polymeric materials. Polyhedral oligomeric silsesquioxane, silsesquioxane, polyhedral oligomeric silicate, silicates, and silicones or metallized-polyhedral oligomeric silsesquioxane, silsesquioxane, polyhedral oligomeric silicate, silicates, and silicones are hereinafter referred to as “silicon containing agents”.

Silicon containing agents have previously been utilized to complex metal atom(s), U.S. Pat. No. 6,441,210. As discussed in U.S. patent application Ser. No. 10/238,923, such silicon containing agents are useful for the dispersion and alloying of silicon and metal atoms with polymer chains uniformly at the nanoscopic level. Silicon containing agents can be converted in the presence of oxidizing agents such as ozone, oxygen plasma, and corona discharge to form a glass-like silica layer.

Prior art in metallized-polyhedral oligomeric silsesquioxane, silsesquioxane, polyhedral oligomeric silicate, silicates, and silicones has focused on their utility in catalysis and several of these catalysts are now commercially sold. Consequently, the majority of metals contained in the periodic table have been incorporated into the silicon containing agents. However, the use of metallized silicon containing agents as additives for the absorption of radiation and of silicon containing agents as compatibilizers for metal particles has not previously been described.

The use of metal particles incorporated into a polymeric binder for radiation absorption is also known, U.S. Pat. No. 6,583,432. However, this prior art approach is deficient in that it does not afford homogeneous dispersion of metal at the nanoscopic level nor optical transparency, nor does it utilize metallized silicon containing agents to compatibilize metal particles with the polymer matrix. Furthermore, the utility of metallized silicon containing agents for the absorption of radiation, refractive index control, optical property control, and semiconducting properties, along with other surface, material, and electrical property enhancements has not been realized in prior art.

A number of prior art methods are known to produce glass coatings on polymers. Such methods include elevated temperature sintering, sputtering, vapor deposition, sol-gel, and coating processes, which all require additional manufacturing steps and are not amenable to high speed molding and extrusion processing. These prior art methods also suffer from poor interfacial bonding between the glass and polymer layers. The prior art is also deficient in its ability to incorporate metal and nonmetal atoms and metal particles into a well defined nanoscopic structure within a single glass layer. The prior art is not able to produce nanoscopically thin glass surfaces, and consequently the methods are not amenable to the high speed manufacture of flexible films and molded polymeric components.

### SUMMARY OF THE INVENTION

We have discovered that silicon containing agents are also useful in combination with metallic particles for absorbing radiation. In such capacity, the silicon containing agents are themselves effective as compatibilizers of the metal particles with polymers as well as carriers of metal atoms. Furthermore, the silicon containing agents and metal particles can be utilized for the in situ formation of nanoscopically thin glass barriers upon exposure to oxygen plasma, ozone, or an oxidizing flame. The process results in a nanoscopically thin glass layer which contains metal atoms and metal particles. The glassified material provides an exceptional barrier to outgassing and to ingression of moisture, and resistance against cleaning agents, in addition to its radiation absorption properties. Nanoscopically thin glass layers containing metals absorb photon and particle radiation that could otherwise damage polymer surfaces and substrates.

A related application is the use of nanoscopically thin glass layers containing mixtures of metals as phosphors and as semiconducting layers on materials. Related art pertaining to the use of silicon containing agents for the isolation of a semiconducting particle is described in U.S. Patent Application Publication No. 2006/0040103 A1 filed Feb. 23, 2006.

The silicon containing agents of most utility in this work are best exemplified by those based on low cost silicones, silsesquioxanes, polyhedral oligomeric silsesquioxanes, and polyhedral oligomeric silicates. FIG. 1 illustrates some representative silicon containing agents that are siloxane, silsesquioxane, and silicate examples. Preferably, metallized versions of silsesquioxanes, polyhedral oligomeric silsesquioxanes, and polyhedral oligomeric silicates are utilized. FIG. 2 illustrates some representative examples. The R groups in such structures can range from H, to alkane, alkene, alkyne, aromatic and substituted organic systems including ethers, acids, amines, thiols, phosphates, and halogenated R groups including fluorinated groups.

The silicon containing agents all share a common hybrid (i.e. organic-inorganic) composition in which the internal framework is primarily comprised of inorganic silicon-oxygen bonds. Upon further oxidation these systems readily form silica glasses. The exterior of a nanostructured silicon containing agent is covered by both reactive and nonreactive organic functionalities (R), which ensure compatibility and tailorability of the nanostructure with organic polymers. These and other properties of nanostructured chemicals are discussed in detail in U.S. Pat. No. 5,412,053, and U.S. Pat. No. 5,484,867. These nanostructured chemicals are of low density, and can range in diameter from 0.5 nm to 5.0 nm.

The metal particles of preferred utility for shielding against radiation include: all inorganic and organometallic derivatives of gadolinium, samarium, and boron for shielding against neutrons; and all inorganic and organometallic derivatives of tungsten, molybdenum, niobium, tantalum, samarium and gadolinum for shielding against X-rays. Other metals with a high atomic number such lead and cadmium may also be utilized.

Metal particles of preferred utility for producing luminescent and semiconducting, and magnetic properties in combined mixtures with metallized and nonmetallized silicon containing agents include Tb, Er, Au, Ag, Pt, Pd, Fe, FeO, GaAs, GaN, GaSb, AlGaAs, InAs, InP, InSb, InN, InGa, InGaP, InGaP, InGaAs, InAsSb, GaInAsP, TiO₂, CdS, CdSe, CdTe, ZnS, PbS, CeO₂, ZnO₂, Al₂O₃, AlN, diamond, FeNi, SmCo₅, Sm₂Co₁₇, NdBFe, and AlNiCo.

### BRIEF DESCRIPTION OF THE DRAWINGS

FIG. 1 shows representative structural examples of nonmetallized silicon containing agents.

FIG. 2 shows representative structural examples of metallized silicon containing agents.

FIG. 3 illustrates the chemical process of oxidative conversion of silicon containing agents into a fused nanoscopically thin glass layer.

FIG. 4 is a comparison of neutron shielding for compositions relative to thickness.

FIG. 5 is an Energy Dispersive X-ray Analysis (EDAX) showing metal content in a chip cap.

FIG. 6 is a comparison of X-ray shielding for compositions relative to thickness.

FIG. 7 illustrates glue-stick and coating application methods of material.

FIGS. 8(a) and 8(b) illustrate design variations utilizing the compositions for chip caps and chip caps containing a metal foil liner.

FIG. 9 illustrates design variation for application of compositions to chips.

### DEFINITION OF FORMULA REPRESENTATIONS FOR NANOSTRUCTURES

For the purposes of understanding this invention's chemical compositions the following definitions for formula representations of silicon containing agents and in particular Polyhedral Oligomeric Silsesquioxane (POSS) and Polyhedral Oligomeric Silicate (POS) nanostructures are made.

Polysilsesquioxanes are materials represented by the formula [RSiO_{1.5}]_{∞} where ∞ represents molar degree of polymerization and R=represents organic substituent (H, siloxy, cyclic or linear aliphatic or aromatic groups that may additionally contain reactive functionalities such as alcohols, esters, amines, ketones, olefins, ethers or which may contain halogens). Polysilsesquioxanes may be either homoleptic or heteroleptic. Homoleptic systems contain only one type of R group while heteroleptic systems contain more than one type of R group.

A subset of silicon containing agents are classified as POSS and POS nanostructure compositions are represented by the formula:
[(RSiO_{1.5})ₙ]_{Σ#} for homoleptic compositions
[(RSiO_{1.5})ₙ(R′SiO_{1.5})ₘ]_{Σ#} for heteroleptic compositions (where R≠R′)
[(RSiO_{1.5})ₙ(RSiO_{1.0})ₘ(M)ⱼ]_{Σ#} for heterofunctionalized heteroleptic compositions
[(RSiO_{1.5})ₙ(RXSiO_{1.0})ₘ]_{Σ#} for functionalized heteroleptic compositions (where R groups can be equivalent or inequivalent)

In all of the above R is the same as defined above and X includes but is not limited to siloxide, OH (silanol), Cl, Br, I, alkoxide (OR), acetate (OOCR), peroxide (OOR), amine (NR₂) isocyanate (NCO), and R. The symbol M refers to metallic elements within the composition that include high and low Z metals and in particular Al, B, Ga, Gd, Ce, W, Ni, Eu, Y, Zn, Mn, Os, Ir, Ta, Cd, Cu, Ag, V, As, Tb, In, Ba, Ti, Sm, Sr, Pb, Lu, Cs, Tl, Te. The symbols m, n and j refer to the stoichiometry of the composition. The symbol Σ indicates that the composition forms a nanostructure and the symbol # refers to the number of silicon atoms contained within the nanostructure. The value for # is usually the sum of m+n, where n ranges typically from 1 to 24 and m ranges typically from 1 to 12. It should be noted that Σ# is not to be confused as a multiplier for determining stoichiometry, as it merely describes the overall nanostructural characteristics of the system (aka cage size).

### DETAILED DESCRIPTION OF THE INVENTION

The present invention teaches the use of silicon containing agents as alloying agents for the absorption of radiation, control of electronic properties, and for the in situ formation of glass layers in polymeric materials and the reinforcement of polymer coils, domains, chains, and segments at the nanoscopic level. The present invention describes a new series of formulated polymeric compositions and their utility as shielding of integrated circuits or other electronic components against radiation damage. The compositions are suitable for manufacturing molded components that can be applied directly to packaged or bare integrated circuits. The preferred manufactured product form is as chip-caps or hotmelt wax stick that can be directly applied to an integrated circuit at the thickness necessary to provide the desired level of radiation shielding. The compositions are also suitable for application as low viscosity conformal coatings that can be cured into a nonflowable form by addition or condensation polymerizations. All of the compositions employing silicon containing agents can be surface glassified to prevent outgassing (for space applications) or in order to provide addition protection against environmental exposure such as sunlight, moisture or chemical attack.

The preferred compositions presented contain primary material combinations of metallized and nonmetallized silicon containing agents, with metal foils, metallic and ceramic powders, and a polymer of thermoplastic, rubber, elastomeric, or thermosetting resin of manmade or natural origin.

The preferred method of preparing the compositions involves mixing of the metallized or nonmetallized silicon containing agent into the polymer along with a metal powder and subsequent molding of a chip cap, a glue stick or bottling as a curable coating. All types and techniques of blending, including melt blending, dry blending, solution blending, milling, reactive and nonreactive blending are effective. Alternatively, the silicon containing agent can be coated on the particles prior to blending into the polymer.

Another preferred method of preparing chip cap compositions involves mixing of the metallized or nonmetallized silicon containing agents into the polymer followed by sandwiching a metal foil in between two layers of the material. The polymer-metal-polymer laminate is suitable for use in thermoforming and stamping applications to produce chip caps.

The selective incorporation and maximum loading levels of a silicon containing agent into a specific polymer can be accomplished though use of a silicon containing agent with a chemical potential (miscibility) compatible with the chemical potential of the region within the polymer in which it is to be alloyed. Because of their chemical nature, silicon containing agents can be tailored to show compatibility or incompatibility with selected sequences and segments within polymer chains and coils. Their physical size in combination with their tailorable compatibility enables silicon containing agents based on nanostructured chemicals to be selectively incorporated into polymers and to control the dynamics of coils, blocks, domains, and segments, and subsequently favorably impact a multitude of physical properties. The use of silicon containing agents increases the metal content of the final formulation, and improves its ability to be fabricated into a film, laminate, molded article, or use as an adhesive, potting agent, or glob-top.

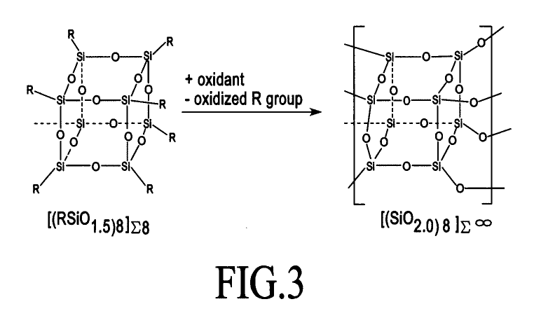

Silicon containing agents also provide for the in situ formation of glass glazings on articles molded from the resulting compositions. Chemical oxidation methods such as ozone, corona discharge, flame, and oxygen plasma are desirable methods for the in situ glass layer formation. There are no topological constraints on the molded articles. Both thin films and thick parts derived from the compositions can be processed to contain nanometer thick surface glass layers. The most efficient and thereby preferred oxidation method is oxygen plasma. Compositions containing silicon containing agents where the R group is H, methyl or vinyl, are highly desirable as they can be rapidly converted to glass upon exposure to ozone, peroxide, or even hot steam. The choice of method is dependent upon the specific composition, loading level of the silicon containing agent, surface segregation of the silicon containing agent, the thickness of the glass layer desired and manufacturing considerations. The process of oxidative conversion of a silicon containing agent into a fused nanoscopically thin glass layer is shown in FIG. 3.

Upon exposure of the surface to the oxidation source, a nanoscopically thin layer of glass from 1 nm to 500 nm will result. If the silicon containing agent contained a metal, then the metal will also be incorporated into the glass layer. In addition to radiation resistance, advantages derived from the formation of a nanoscopically thick glass surface layer include barrier properties for gases and liquids, reduction of outgassing from the molded article, improved oxidative stability, flammability reduction, improved electrical properties, improved printability, improved stain and scratch resistance and improved environmental resistance.

The keys that enable silicon containing agents such as nanostructured chemicals to function in this invention include: (1) their unique size with respect to polymer chain dimensions, (2) their ability to be compatibilized and uniformly dispersed at the nanoscopic level with polymer systems to overcome repulsive forces that promote incompatibility and expulsion of the nanoreinforcing agent by the polymer chains, (3) their hybrid composition and ability glassify upon exposure to oxidants, (4) their ability to chemically incorporate metal atoms and alloys into the cage structure, and (5) the ability to compatibilize metal and ceramic particles and thereby increase the homogeneity and loading level of metal within a resulting polymeric composition.

The factors that affect selection of a silicon containing agent for radiation absorption include the specific wavelength of radiation, the loading level of the silicon containing agent, metal atoms and particles, and the optical, electronic, and physical properties desired in the final material composition.

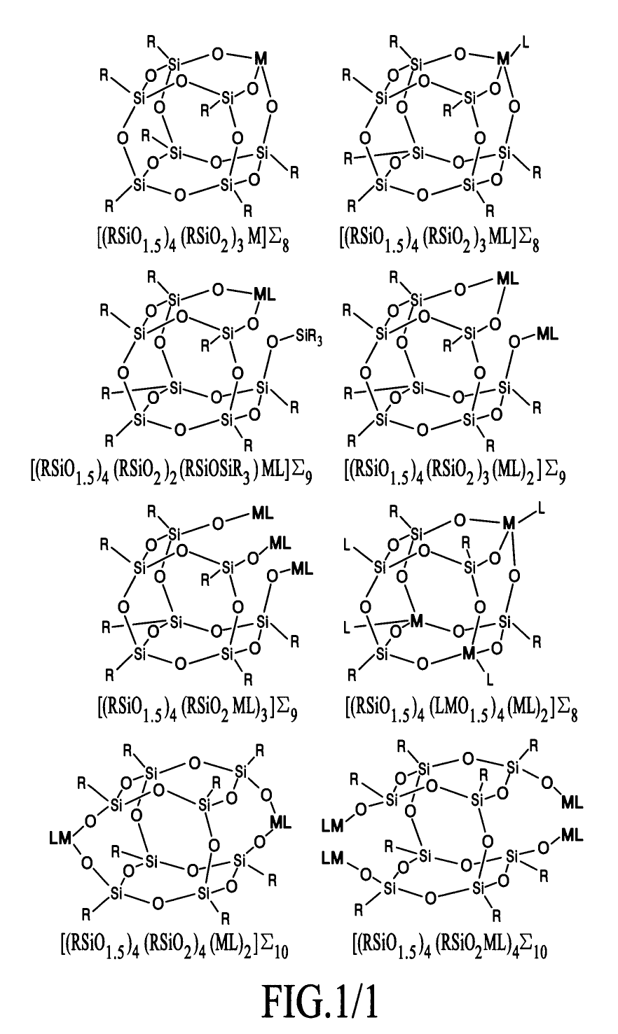

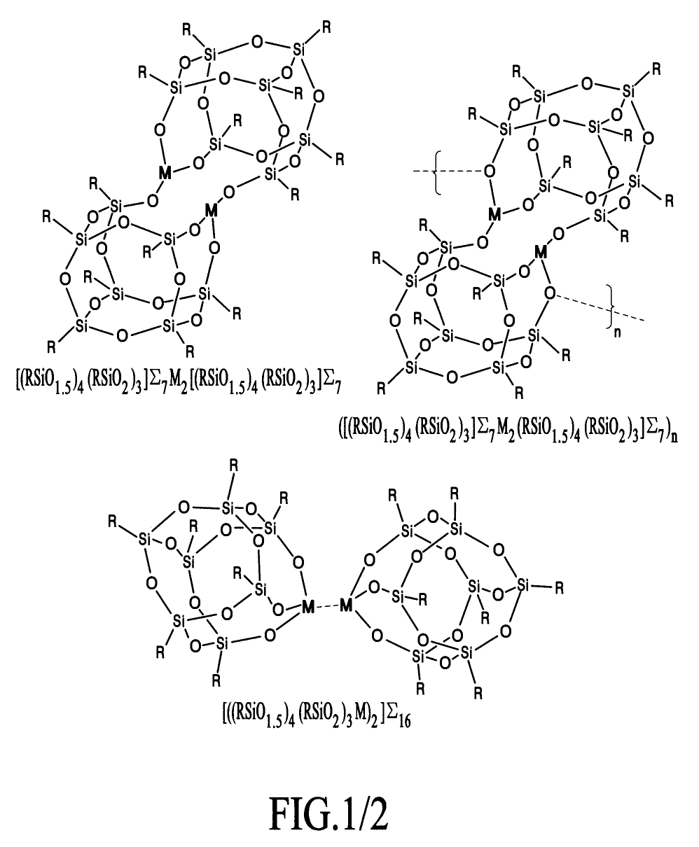

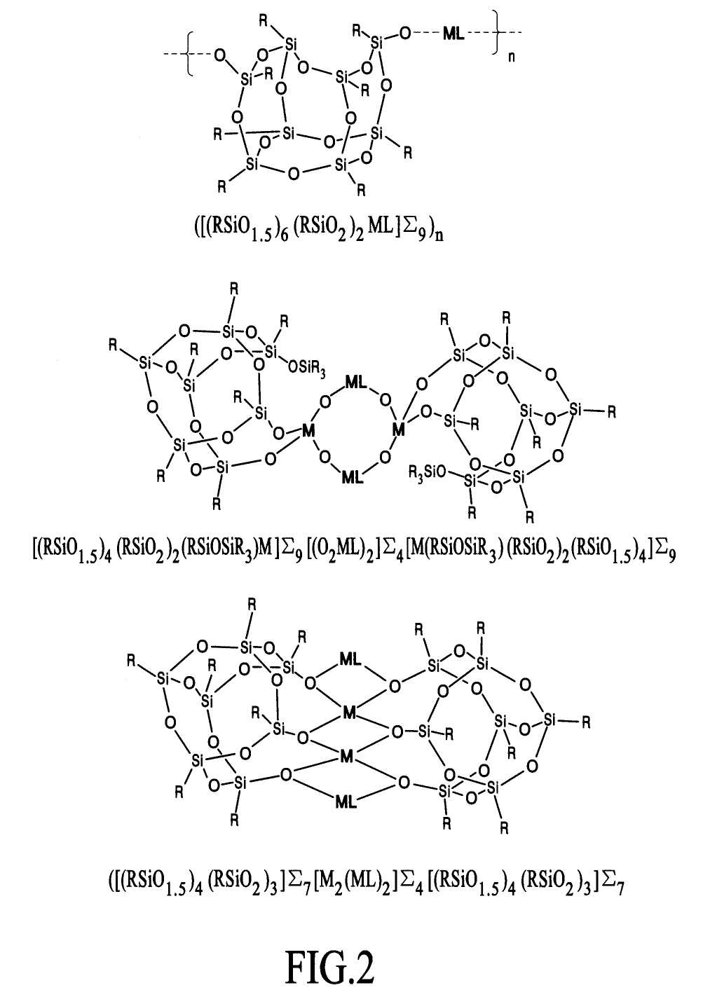

Silicon containing agents, such as the polyhedral oligomeric silsesquioxanes illustrated in FIG. 1, and metallized polyhedral oligomeric silsesquioxanes such as those in FIG. 2, are available as solids and oils. Both forms dissolve in molten polymers or in solvents, or can be reactively on nonreactively incorporated into polymers. The dispersion of silicon containing agents appears to be thermodynamically governed by the free energy of mixing equation (ΔG=ΔH−TΔS). The nature of the R group and ability of the reactive groups on the cage to react or interact with polymers and surfaces greatly contributes to a favorable enthalpic (ΔH) term while the entropic term (ΔS) is highly favorable because of the monoscopic cage size and distribution of 1.0.

The above thermodynamic forces driving dispersion are supplemented by kinetic mixing forces such as those that occur during high shear mixing, solvent blending or alloying. The kinetic dispersion is also aided by the ability of some silicon containing agents to melt at or near the processing temperatures of most polymers.

Silicon containing agents can also be utilized in combination with macroscopic fillers to render improved homogeneity of dispersion and compatibility, which provides enhancement of electronic properties, physical properties, barrier, stain resistance. Thus silicon containing agents can be used in combination with tungsten, boron, or gadolinium particles to provide highly effective coatings with resistance toward ionizing photon and neutron radiation and toward non-ionizing radiation. In such instances, metallized silicon containing agents containing samarium and gadolinium are also of particular utility by improving the level of metal loading. Such formulations are of high value for electronics that are sensitive to neutron induced memory upset as well as space-vehicle mirrors, portals, structures, sensors, and for food packaging, cosmetics and biological materials.

The present invention shows that property enhancements can be realized in molded components and coatings by the direct blending of silicon containing agents and metallic powders into polymers. This greatly simplifies the prior art processes.

Furthermore, because silicon containing agents like nanostructured chemicals possess spherical shapes (per single crystal X-ray diffraction studies), like molecular spheres, and because they dissolve, they are also effective at reducing the viscosity of polymer systems. This benefits the processing, and molding, coating or lamination of articles using such nano-alloyed polymers, yet with the added benefits of reinforcement of the individual polymer chains due to the nanoscopic nature of the chemicals. Subsequent exposure of the nano-alloyed polymers to oxidizing agents results in the in situ formation of nanoscopic glass on the exposed surfaces of molded articles (FIG. 3). Upon exposure of the nano-alloyed polymer to an oxidizing source the silicon-R bonds are broken and the organic R group is lost as a volatile reaction byproduct while the valency to the silicon is maintained through the fusing of cages together by bridging oxygen atoms, thus rendering the equivalent of fused glass. Thus, ease of in situ formation of this glass surface layer is obtainable through the use of nanostructured silicon containing agents where as prior art would have required the use a secondary coating or deposition method that would have resulted in formation of a micron thick layer of glass on the surface. Such glass layers are also advantageous as the provide a more desirable surface for printing product information directly on a package. Additional benefit from the use of such nano-alloyed polymers is the ability of such materials to self-heal in the event of a loss of the surface glass layer. In such an event, the nanoscopic silicon containing agents present underneath the original glass surface would the be available to undergo in situ conversion to a new and healing glass surface layer upon exposure to the oxidant. Such control over compatibility, dispersability, size, and manufacturability is unprecedented for all traditional fillers and coating technologies. Loading levels of the silicon containing agent can range from 1% to 99% by weight, with a preferred range from 1% to 50% by weight, while metal particle loadings can range from 1% to 50% by weight, with a preferred loading range from 5% to 50% by weight, with the remainder of the composition being composed of polymer.

### EXAMPLES

### General Process Variables Applicable to All Processes

As is typical with chemical processes there are a number of variables that can be used to control the purity, selectivity, rate, and mechanism of any process. Variables influencing the process for the incorporation of silicon containing agents (e.g. silicones and silsesquioxanes) into plastics include the size, polydispersity, and composition of the nanoscopic agent. Similarly, the molecular weight, polydispersity and composition of the polymer system must also be matched between the silicon containing agent and polymer. Finally, the kinetics, thermodynamics, processing aids, fillers, and type of metal powders used during the compounding or mixing process can impact the loading level and degree of enhancement resulting from incorporation. Blending processes such as melt blending, dry blending and solution mixing blending are all effective at mixing and alloying nanoscopic silica agents into plastics.

Alternate Method: Solvent Assisted Formulation. Silicon containing agents can be added to a vessel containing the desired polymer, prepolymer or monomers and dissolved in a sufficient amount of an organic solvent (e.g. hexane, toluene, dichloromethane, etc.) or fluorinated solvent to effect the formation of one homogeneous phase. The mixture is then stirred under high shear at sufficient temperature to ensure adequate mixing for 30 minutes, and the volatile solvent is then removed and recovered under vacuum or using a similar type of process including distillation. Note that supercritical fluids such as CO₂ can also be utilized as a replacement for flammable hydrocarbon solvents. The resulting formulation may then be used directly or for subsequent processing.

### Example 1

### Compositions Desirable for Neutron Shielding

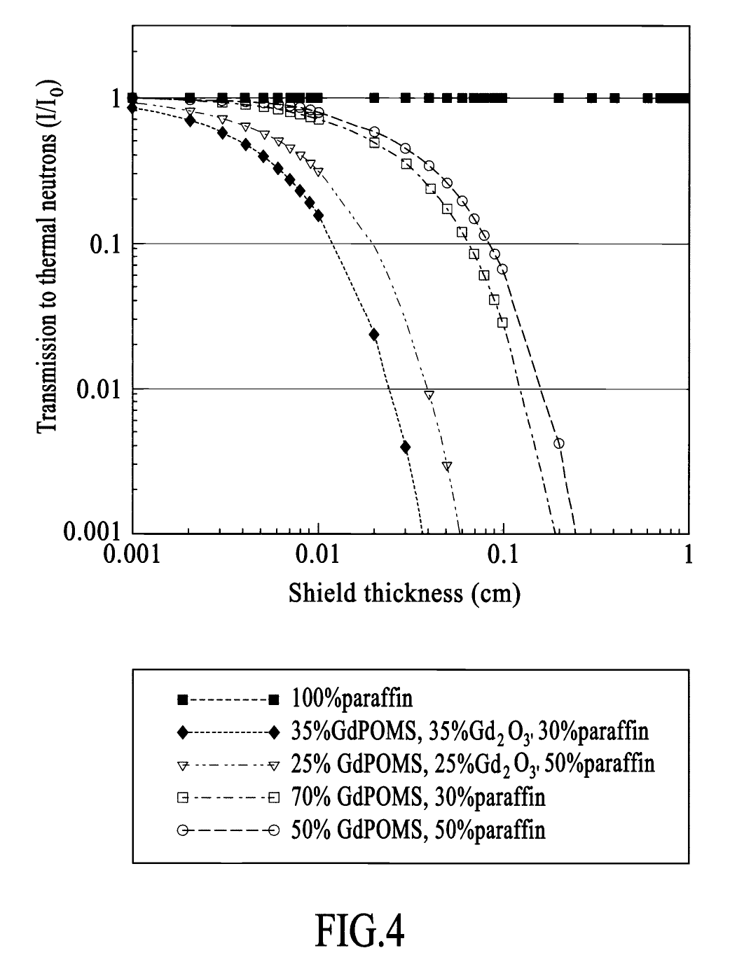

Compositions capable of providing a range of shielding for electronics components against thermal neutron damage are easily formulated. The shielding level is controllable by the thickness of material around the component and the loading level of absorber within the material. For example, a composition containing 70 wt % Gd POMS (POMS=polyhedral oligometallasilsesquioxane) and 30% paraffin is able to provide nearly complete shielding at a thickness of 3 mm, while a composition containing 35% Gd POMS/35% Gd₂O₃/30% paraffin is effective at approximately 0.5 mm thickness. The ability to tailor the shielding level by thickness and composition provides a means to minimize cost and amount of the shielding material. The plot in FIG. 4 provides the relationship between shielding level (transmission of thermal neutrons) relative to thickness of each composition.

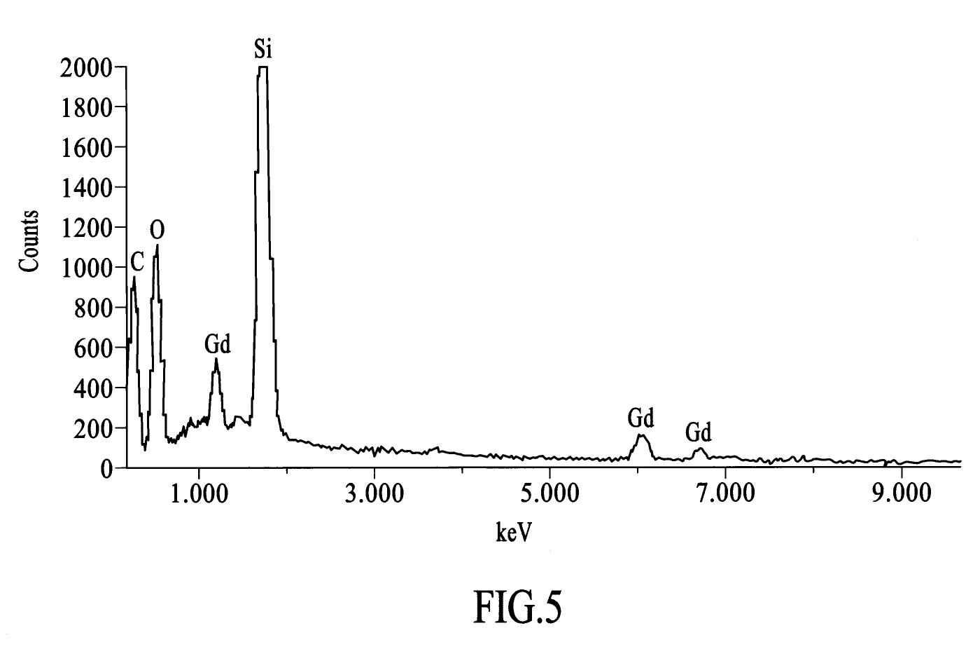

The use of POMS also provides a means for improving the hydrophobicity of the metal oxide as a result of the organic R groups on the cage and its homogeneous dispersion throughout the material (see U.S. patent application Ser. No. 11/015,185). It is possible to measure the compositional homogeneity of elements within a material using Energy Dispersive X-ray Analysis (EDAX). High-resolution measurements can determine the differences in composition at different positions on a sample and such an analysis helps evaluate the performance of this material as a radiation shielding layer. FIG. 5 shows compositional EDAX spectrum of the Gd metallized POMS in combination with Gd₂O₃ metal oxide powder and paraffin wax shows the uniform presence of carbon C, Gd, Si, and O throughout the chip cap and dispersion at the nanoscopic level.

### Example 2

### Compositions Desirable for X-Ray Shielding

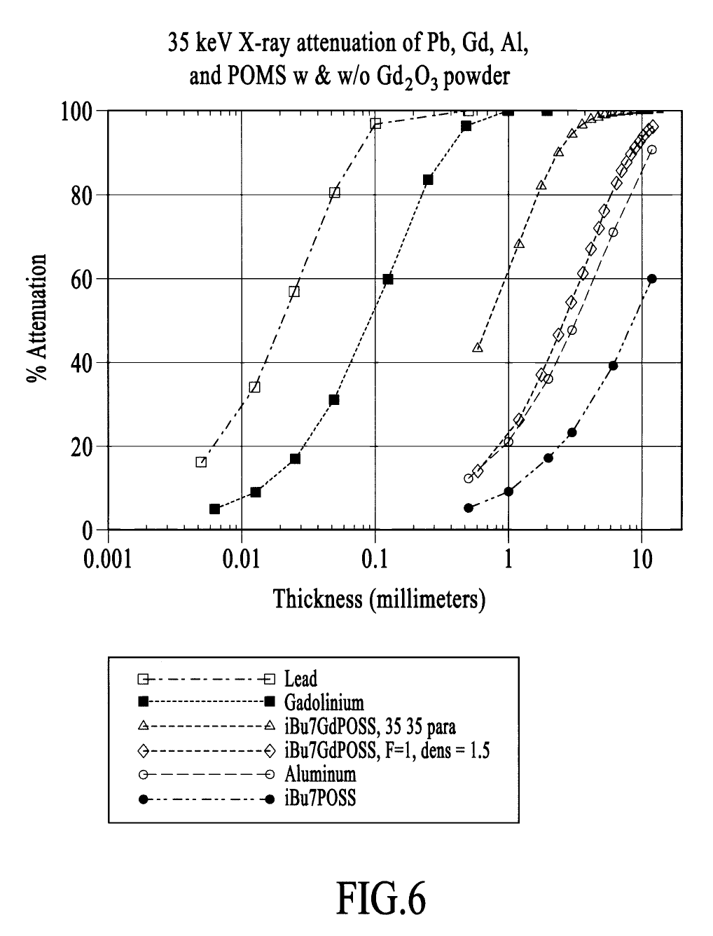

Compositions capable of providing a range of shielding for electronics components against X-ray damage are easily formulated. The shielding level is controllable by the thickness of material around the component and the loading level of absorber within the material. For example a composition containing 70 wt % Gd POMS (POMS=polyhedral oligometallasilsesquioxane) and 30% paraffin is able to provide nearly complete shielding at a thickness of 12 mm while a composition containing 35% Gd POMS/35% Gd₂O₃/30% paraffin is effective at approximately 5 mm (FIG. 6).

The ability to tailor the shielding level by thickness and composition provides a means to minimize shielding cost and thickness. Additionally, compositions containing metal atoms, metals, or metal oxide powders are able to dissipate electrostatic charge and electrical charges that can result in conductors. Such compositions are well suited to charge dissipation in wire, cables, and cable harnesses, while maintaining resistance to moisture and abrasion.

### Example 3

### Chip Encapsulation

A typical chip scale packaging process starts with the mounting of the bare die on the interposer using epoxy, usually of non-conductive type (although conductive epoxy is also used when the die backside needs to be connected to the circuit). The die is then wire bonded to the interposer using gold or aluminum wires. Wirebond profiles must be as low and as close to the die as possible in order to minimize package size.

Plastic encapsulation to protect the die and wires then follows, usually by transfer molding. After encapsulation, solder in the form of balls or connections is attached to the bottom side of the interposer, after which the package is marked. Finally, the parts are singulated from the leadframe.

Application of shielding compositions can be applied to the bare die at the plastic encapsulation step mentioned above. In this instance, dispersment of the metallized or nonmetallized silicon containing agents and metal particles can be incorporated into a conductive or nonconductive epoxy, bismaleimide, acrylic, phenolic or other suitable thermosetting or UV curable resin system.

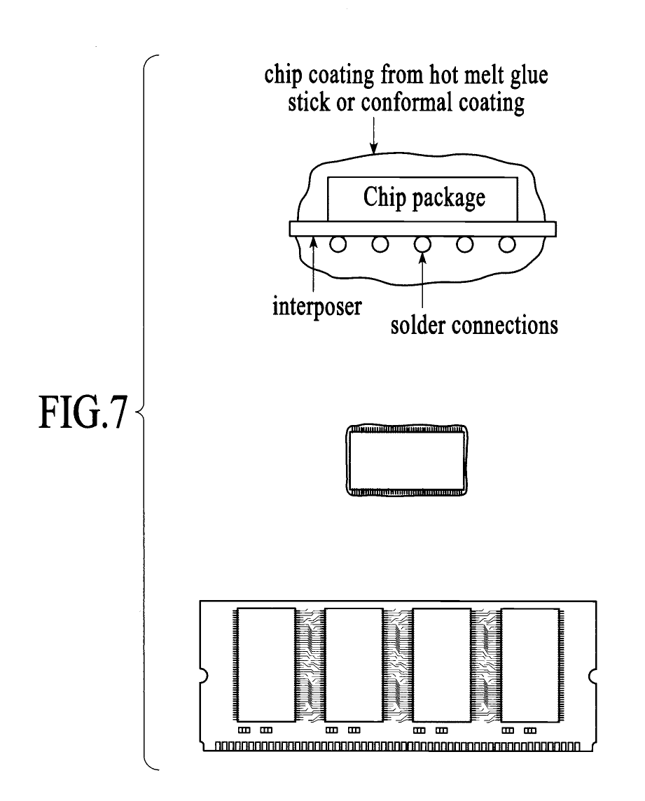

Alternatively, the shielding compositions can be applied to the plastic or ceramic packaged chip through the use of a conformal coating that contains the metallized or nonmetallized silicon containing agents and metal particles and then cured into place. Further the coating formulations can be applied to the plastic or ceramic packaged chip through use of a hot wax glue gun and a meltable wax stick containing the metallized or nonmetallized silicon containing agents and metal particles. Application of either the curable coating or the hot melt wax will result in an adequately coated chip as shown in FIG. 7.

### Example 4

### Chip Cap Design, Manufacture and Application

A preferred method of applying the compositions involves the molding of chip caps that precisely fit and control the thickness of material surrounding the top, sides and bottom of the chips desired to be protected.

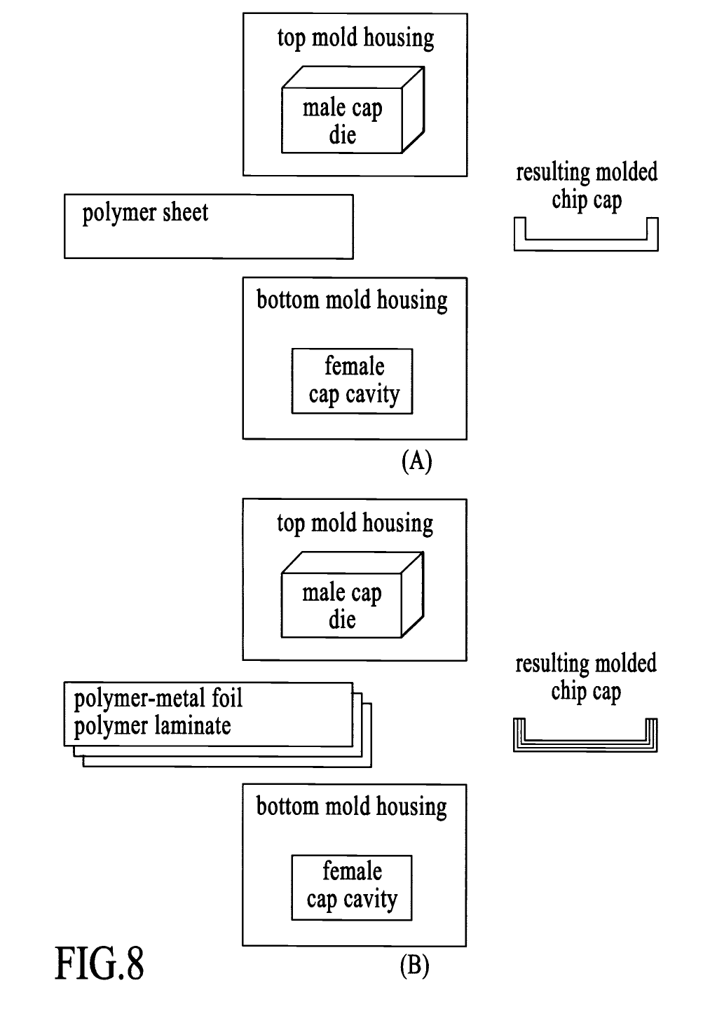

This method involves the mixing of the metallized or nonmetallized silicon containing agents and metal powder with a thermoplastic polymer. Most preferably, commercially available hot melt glue sticks can be utilized. The composition is then injection molded to form a cap of the desired thickness and to snugly fit to the chip. The composition can also be molded into a sheet and thermoformed using a die and cavity to render an appropriately sized chip cap (FIG. 8a). An additional variation can use the composition for the sandwich lamination of a metal foil between to layers of the composition. This laminate is then suitable for thermoforming into chip caps that contain both the shielding composition and a metallic interlayer to render additional shielding protection (FIG. 8b). Desirable metals for the inner layer include gadolinium, boron, samarium, and tungsten.

The bottom of the chip can also be protected against radiation through use of a similarly molded chip cap or by application of the composition via a hot melt glue stick or curable coating as described previously (FIG. 7).

The chip caps and the coatings described can also be glassified to provide assurance against outgassing or ingression of moisture and undesirable chemicals. The surface glassification process can be carried out on premolded chip caps or on capped or coated chips. Typical oxygen plasma treatments range from 1 seconds to 5 minutes under 100% power. Typical ozonolysis treatments range from 1 second to 5 minutes with ozone being administered through a dichloromethane solution or in an ozone/oxygen gas stream.

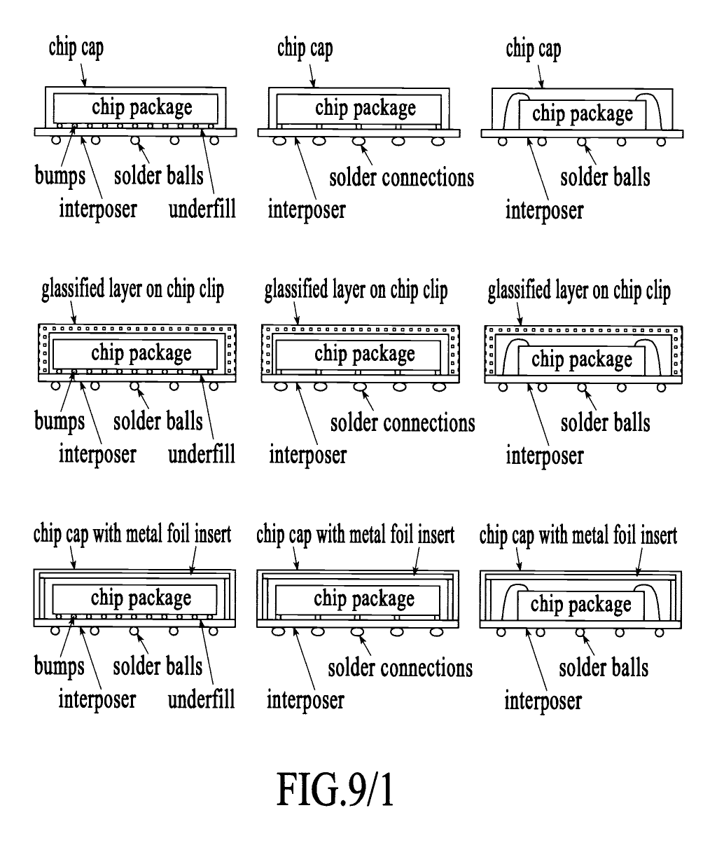

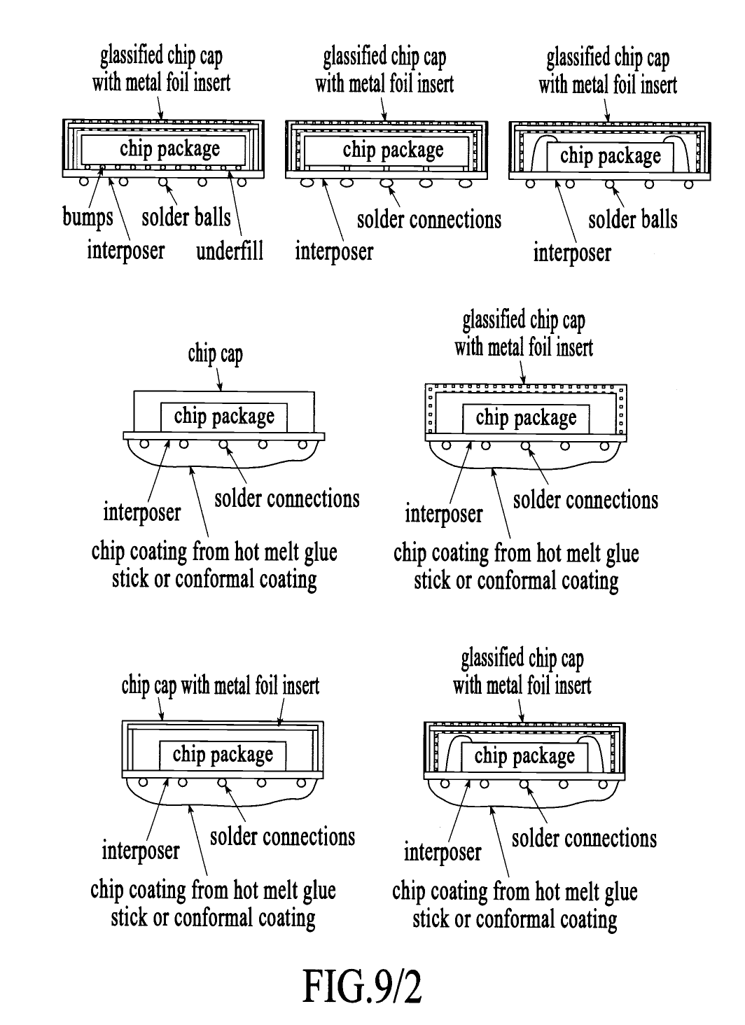

A number of design variations for capping and coating chips are illustrated in FIG. 9. The process of coating chips using hot melt wax, conformal coating, and chip caps can be used simultaneously or singularly.

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A radiation shield for an electronic component comprising:
(a) a silicon containing agent selected from the group consisting of nanostructured polyhedral oligomeric silsesquioxanes, polyhedral oligomeric silicates, silicates, silsesquioxanes, and silicones;
(b) a metal; and
(c) a polymeric carrier.

2. The shield of claim 1, wherein at least some of the metal is bonded to the silicon containing agent in a metallized silicon containing agent.

3. The shield of claim 1, wherein the silicon containing agent is selected from the group consisting of POSS and POS.

4. The shield of claim 1, wherein the metal is selected from the group consisting of gadolinium, samarium, boron, tungsten, molybdenum, niobium, tantalum, lead, and cadmium.

5. The shield of claim 3, wherein at least some of the metal is bonded to the silicon containing agent in a metallized silicon containing agent.

6. The shield of claim 1, wherein the surface of the silicon containing agent is oxidized to form a glass layer.

7. The shield of claim 1, wherein at least some of the metal is a powder that is mixed into the composition.

8. The shield of claim 1, wherein the shield is provided in a form selected from the group consisting of chip cap, glue stick, and curable coating.

9. The shield of claim 1, wherein at least some of the metal is provided as a foil.

10. The shield of claim 9, wherein the metal foil is laminated between a plurality of layers of the polymeric carrier.
